(19) United States
(12) Patent Application Publication
(10) Pub. No.: US 2023/0015838 A1
(43) Pub. Date: Jan. 19, 2023

(54) PENETRATION FOOD THERMOMETER

(71) Applicant: VORWERK & CO. INTERHOLDING GMBH, Wuppertal (DE)

(72) Inventors: Matthias Stein, Mulheim an der Ruhr (DE); Mirco Serndt, Velbert (DE); Fabian Schulz, Oberhausen (DE)

(21) Appl. No.: 17/852,691

(22) Filed: Jun. 29, 2022

(30) Foreign Application Priority Data
Jul. 16, 2021 (EP) 21186000.2

(51) Int. Cl. G01K 7/04; G01K 1/024

(52) U.S. Cl. CPC G01K 7/04; G01K 1/024; G01K 2207/06

(57) ABSTRACT

An electrical penetration food thermometer having an elongated probe, a temperature sensor within the probe, an energy converter capable of generating an electrical power from a temperature difference, and a heat conductor thermally conductively connected to the energy converter.

### CROSS-REFERENCE TO RELATED APPLICATION

This application claim benefit of priority to European Patent Application No. 21186000.2, filed on Jul. 16, 2021, the disclosure of which is hereby incorporated in its entirety by reference herein.

### TECHNICAL FIELD

The present disclosure relates to an electrical penetration food thermometer.

### BACKGROUND

A food is a nourishment that is prepared. Preparation may comprise warming or heating. Examples of a food that can be prepared by warming or heating include meat, vegetables, or dough for baked goods.

A food thermometer is a temperature measuring device designed and suitable for measuring temperatures in a food product during its preparation. A food thermometer can therefore measure temperatures that may occur during the preparation of a food. Temperatures that significantly deviate from this cannot be measured. In addition, a food thermometer can withstand the environmental conditions that can occur during the preparation of a food.

As a rule, temperatures of less than 200° C. are reached when preparing a food. However, temperatures of 350° C. may also be reached, for example for baking a pizza. Temperatures of more than 350° C. are generally not exceeded.

### SUMMARY

A food thermometer of the present disclosure is therefore configured such that temperatures above 400° C., preferably above 300° C., particularly preferably above 250° C., cannot be measured. In principle, the food thermometer is configured such that it can be used in a conventional baking oven, i.e. at temperatures of up to 250° C.

A food thermometer of the present disclosure is not designed be able to measure very low temperatures, such as temperatures well below sub-zero temperatures as are reached in household freezers. Thus, a food thermometer of the present disclosure is not designed to measure temperatures lower than −70° C. In principle, a food thermometer of the present disclosure is designed such that it cannot measure temperatures below −50° C., because foods are generally produced with a supply of heat and very low temperatures are only used for freezing a food.

A food thermometer of the present disclosure can withstand a steam atmosphere. A food thermometer is therefore generally encapsulated in a waterproof manner. A food thermometer of the present disclosure is resistant to common ingredients of a food such as acid of lemons or vinegar.

A food thermometer of the present disclosure is intended and suitable to be pierced (inserted) into a food in order to be able to measure a temperature inside the food. A penetration food thermometer has an elongated probe with a pointed or at least a very thin end to allow the probe to be pierced also into relatively solid food such as meat. The probe comprises a sensor capable of measuring a temperature. A penetration food thermometer comprises a handle part that is not intended to be inserted into the food. The handle part may be grasped by a user to enable the penetration food thermometer to be withdrawn (removed) from a food. The handle part may also comprise a sensor by means of which a temperature can be measured. The temperature outside of a food or nourishment can then also be measured.

A penetration food thermometer of the present disclosure is an electrical penetration food thermometer may require electrical power for its operation. Thus, an electrical penetration food thermometer may comprise a battery or may be connected to an external electrical power source to be supplied with electrical power.

The penetration food thermometer of the present disclosure is configured to to measure the temperature in a food during preparation independently of an external power supply.

### BRIEF DESCRIPTION OF THE DRAWINGS

The figures show

FIG. 1 illustrates a pen-shaped electrical penetration food thermometer during a food preparation;

FIG. 2 illustrates a section through an electrical penetration food thermometer;

FIG. 3 illustrates an embodiment of an energy converter for an electrical penetration food thermometer;

FIG. 4 illustrates an embodiment of an energy converter for an electrical penetration food thermometer; and

FIG. 5 illustrates a section through an energy converter.

### DETAILED DESCRIPTION

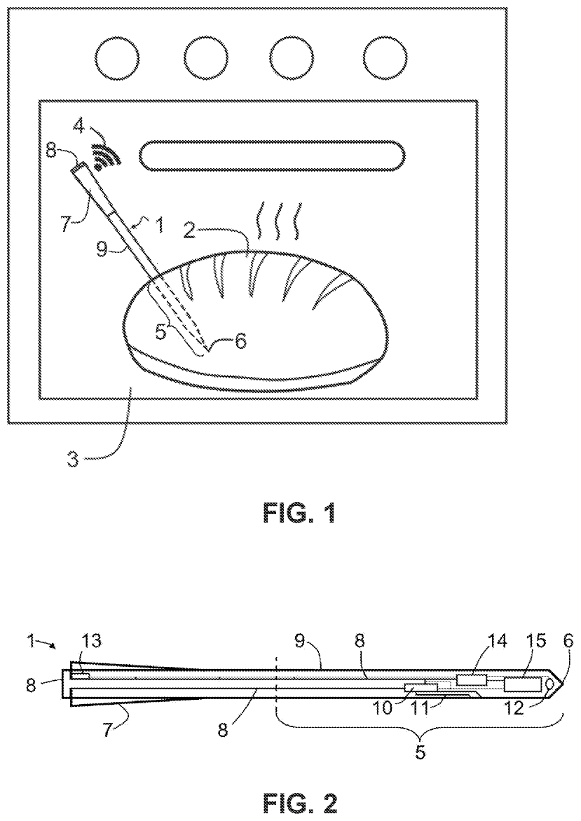

FIG. 1 shows a pen-shaped food thermometer 1 inserted into a bread dough 2. The bread dough 2 is located in an oven 3 and is being heated. The food thermometer 1 measures temperatures and transmits measured temperatures to an external device through a radio unit 4. The bread preparation can be controlled through the external device. The front part of the food thermometer 1 to be inserted into the food product 2 is the probe 5 of the food thermometer 1. Inside the probe 5 there is at least one temperature sensor. To allow the probe 5 to be easily inserted into a food product 2, the probe 5 comprises a tip 6. The probe 5 may be confined to a front third or front half of the food thermometer 1. The rear portion of the food thermometer 1 comprises a casing serving as a handle 7, made of a thermally insulating plastic material such as rubber or elastomer. The rear end of the food thermometer 1 is formed by a heat conductor 8. The heat conductor 8 extends within the casing 9 in the direction of the probe 5. The heat conductor 8 may include copper, for example. The housing 9 may include stainless steel or aluminum, for example.

The thermometer 1 is intended and suitable to be pierced into a food product 2. It is therefore a penetration food thermometer.

Also the rear end of the food thermometer 1 may comprise one or more temperature sensors to also measure the ambient temperature during the preparation of a food.

FIG. 2 shows a section through an electrical penetration food thermometer 1, which is similar to the electrical penetration food thermometer 1 shown in FIG. 1. Inside the housing 9, namely in the front third, there is an energy converter 10. The energy converter 10 is structured like a Peltier element. The substantially rod-shaped heat conductor 8 contacts the energy converter 10 in such a way that it adjoins an electrical contact point of the energy converter 10. Another heat conductor 11 adjoins the other electrical contact point of the energy converter 10. The other heat conductor 11 is further connected to the housing 9. The other heat conductor 11 may also include copper. A temperature sensor 12 is located at the tip 6. A temperature sensor 13 is located at the rear end of the food thermometer 1. Both temperature sensors 12 and 13 are electrically connected to a control electronics 14 of the food thermometer 1. The energy converter 10 is electrically connected to a battery 15 located between the temperature sensor 12 and the control electronics 14. The control electronics 14 comprise a wireless radio unit. The control electronics 14 may be electrically connected to the heat conductor 8. The substantially rod-shaped heat conductor 8 then serves as an antenna for the radio unit of the control electronics 14. The control electronics 14 may, for example, be arranged between the energy converter 10 and the battery 15.

The probe 5 of the food thermometer 1 is to be pierced into a food. If this is done and the food 2 is in a heated oven 3, the rear end 8 of the food thermometer 1 is heated. Via the substantially rod-shaped heat conductor 8, the heat is transported to the one first electrical contact point of the energy converter 10.

The probe 5 is thermally shielded by the food 2. The part of the housing 9 belonging to the probe 5 is therefore hardly heated at first and remains relatively cool. The second electrical contact point of the energy converter 10 is therefore kept cool via the other heat conductor 11. The energy converter 10 then generates electric power which can be used to charge the battery 15.

The temperature sensor 12 can be used to measure the temperature inside a food. The temperature sensor 13 can be used to measure the ambient temperature during the preparation of food.

An electrical conductor may be attached to the rod-shaped heat conductor 8, which connects the temperature sensor 13 at the rear end of the penetration food thermometer to the control electronics 14. The heat conductor 8 can therefore also be used to suitably fix or attach one or more electrical lines.

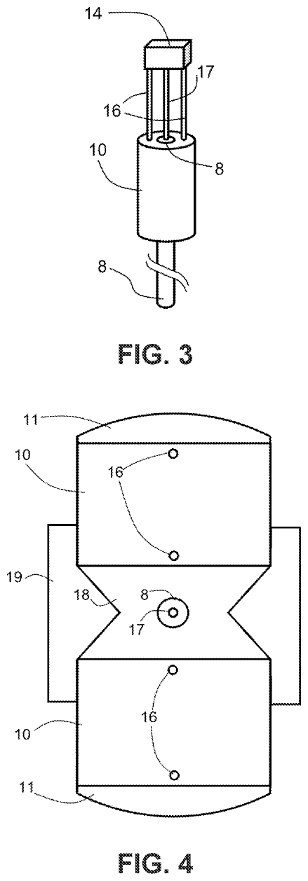

FIG. 3 shows a hollow cylindrical energy converter 10 with a substantially rod-shaped heat conductor 8 for a penetration food thermometer. The rod-shaped heat conductor 8 leads into the hollow cylindrical energy converter 10 to supply heat to an electrical contact point of the energy converter 10. Electrical connections 16 connect the energy converter 10 to the control electronics 14 to provide power to the control electronics 14. An electrical conductor 17 is also connected to the control electronics 14 and to the heat conductor 8.

The heat conductor 8 can now in turn serve, for example, as an antenna for a radio unit of the control electronics 14. The hollow cylinder shape makes it possible to use a significantly larger surface area to generate electricity. In addition, the hollow cylinder shape can directly contact the housing of the food thermometer 1 over a large area in the region of the temperature sensor. Higher efficiencies are thus possible compared to the embodiment described above.

FIG. 4 shows a top view of energy converters 10 for a penetration food thermometer arranged one above the other and separated from each other by a heat-conducting layer 18. A rod-shaped heat conductor 8 leads into the heat-conducting layer 18. Like the rod-shaped heat conductor 8, the heat-conducting layer 18 may include copper. However, other materials with good thermal conductivity are also possible. Thermally insulating layers 19 laterally adjoin the heat-conducting layer 18 and partially on the energy converter 10. The thermally insulating layers 19 prevent the areas of the energy converters 10 that are to be kept cool from heating up. The thermally insulating layers 19 may extend into the thermally conductive layer 18 in the manner of a bulge or tip, for example, to thermally insulate in an improved manner. Thermally conductive layers 11 adjoin the respective energy converter 10 on the upper side and on the lower side. In each case, the surface may be arcuate to produce good contact with the adjacent housing of the penetration food thermometer. The energy converters 10 shown in FIG. 4 may be cuboid. For example, further energy converters may be arranged in pairs in front of and/or behind them.

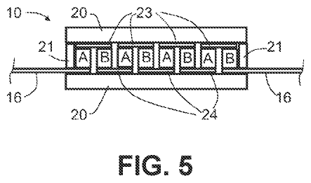

FIG. 5 shows a sectional view of an energy converter 10. The energy converter 10 comprises two outer ceramic layers 20 which are good heat conductors. The two ceramic layers 20 may be thermally separated from each other on the outer sides by a thermally insulating, sufficiently temperature-stable material 21. Within the energy converter 10. there are alternating conductors A and B consisting of metal, for example. The material of conductor A differs from the material of conductor B. Only the ends of the electrical conductors A and B are electrically connected to each other in pairs and offset as shown. This results in two different contact points 23 and 24. One contact point 23 adjoins one outer ceramic layer 20. The other contact point 24 adjoins the other outer ceramic layer 20. If the two different ceramic layers 20 are heated to different temperatures, an electric power is generated. Electrical conductors 16 lead out of the energy converter 10 and can contact a battery, for example, to be able to charge it.

The ceramic layers 20 may be flat. The energy converter 10 can then be cuboid. However, the layers 20 may also be the outer and inner shell of a hollow cylinder. The energy converter 10 can then be hollow cylindrical.

The electrical penetration food thermometer provided to solve the problem comprises an elongated probe. There is a temperature sensor within the probe. “Probe” means the part of the food thermometer which is intended and suitable to be pierced into a food product in order to be able to measure a temperature inside the food product.

The probe is elongated if it is much longer than wide and deep and/or if the diameter is much smaller than the length of the probe. In cross-section, the probe may be circular. However, the probe may be oval, square or polygonal in cross-section. The probe is generally straight so that it can be easily inserted into a food product and easily withdrawn. The probe may be cylindrical. For example, the probe may be at least 3, 4 or 5 cm long. For example, the probe may be no longer than 12, 10 or 8 cm. The probe may be, for example, at most 2 cm or 1 cm wide and/or deep, and/or the diameter may be, for example, at most 2 cm or 1 cm. Since the housing of the probe has a large surface area and is generally thin-walled, it may include a metal that is not optimized in terms of thermally conductive properties. The housing of the probe may therefore consist partly or entirely of stainless steel. However, it may also consist partially or completely of aluminum.

A handle part of the food thermometer is not part of the probe. A handle part is intended and suitable to be grasped in order to pierce the probe into a food product and to withdraw the probe from the food product or the food made from it. Therefore, a handle part typically comprises a sheath or casing made of a thermally insulating material such as plastic.

In order to measure a temperature inside a food product or food, there is at least one temperature sensor inside the probe. A temperature sensor is an electrical or electronic component that provides an electrical signal as a measure of temperature. For example, the temperature sensor may comprise an electrical conductor whose electrical resistance is measured which is dependent of temperature. The measured electrical resistance is then the measure of temperature.

There is an energy converter that converts a temperature difference into an electric power (electric current). There is a heat conductor which is thermally connected to the energy converter. If the energy converter is located inside the probe, the heat conductor leads out of the probe. If the energy converter is located outside the probe, the heat conductor leads into the probe. From a design point of view, it is preferable for the energy converter to be located inside the probe, since the probe is designed for good heat transfer.

If a food thermometer is inserted into a food product and the food product is then heated in an oven, for example, the probe remains comparatively cool compared to the temperature outside the food product. The food thermometer exploits this temperature difference by means of the heat conductor and the energy converter to generate an electric power. The electric power generated in this way can then be used to charge a battery of the food thermometer and/or to supply electrical power to control electronics of the food thermometer.

The heat conductor preferably extends from the energy converter to a free end of the food thermometer to optimize power generation. For example, if the probe is directly connected to a handle part and if the energy converter is located inside the probe, then the heat conductor preferably passes through the handle part, at least through a sheath or casing of the handle part that consists of a thermally insulating material. The heat conductor may then form the end of the handle part. This end of the handle part is generally a blunt end. For example, if the probe is directly connected to a handle part and if the energy converter is located in the handle part, then the heat conductor preferably passes through the entire probe until the heat conductor reaches the corresponding end of the probe. This end of the food thermometer is generally a pointed end.

The heat conductor preferably consists of copper, since copper is a very good heat conductor. The temperature difference can then be used particularly well to generate an electric power. Silver can also be used instead of copper. Less suitable but still possible Is a metal such as gold, aluminum or tungsten.

The heat conductor is preferably completely or at least predominantly rod-shaped in order to be able to extend suitably far within the housing of the food thermometer. For example, the heat conductor may extend from a rear third of the food thermometer to a front third of the food thermometer in order to be able to suitably transport heat for the purpose of generating electricity. The energy converter is then arranged in one of the two thirds.

The length of the heat conductor is preferably at least half as long, preferably at least ⅔ as long as the length of the food thermometer in order to be able to suitably transport heat for generating electricity.

Preferably, the heat conductor is not only used to conduct heat in order to keep the installation space small. For example the food thermometer may comprise a radio device and the heat conductor may be an antenna of the radio device. Measured temperatures may then be transmitted wirelessly to an external receiving device by the radio device. The heat conductor may be an electrical conductor through which generated power may flow to a battery and/or to an electrical consumer of the food thermometer. The heat conductor may serve as a holder for other components of the food thermometer. One or more other components, such as an electrical conductor, are then attached to the heat conductor. This electrical conductor may, for example, connect a temperature sensor to control electronics.

As an energy converter, a circuit with two different electrical conductors may be provided for the generation of electrical power by means of the Seebeck effect. By Seebeck effect is meant the generation of a voltage in a circuit with two different conductors at a temperature difference at the contact points. The heat conductor may adjoin (be adjacent to) a contact point to bring it to a different temperature than the other contact point during operation.

In a preferred embodiment, the energy converter is a hollow cylinder. This allows different temperatures to be achieved at contact points in an improved manner. The efficiency for power generation can thus be increased. This applies in particular if the probe is also cylindrical. In this case, the hollow cylinder can be directly adjacent to the housing of the probe so that contact points adjacent to it are optimally tempered (controlled in temperature). If the probe has only an approximate cylindrical shape, it is advantageous that the energy converter also has a corresponding shape. The energy converter is then also only approximated to the cylindrical shape.

In one embodiment, the heat conductor leads into the hollow cylinder for tempering in an optimized manner. The efficiency of electrical power generation can thus be improved.

The heat conductor preferably adjoins one of the two contact points in order to optimize the desired tempering. The heat conductor may then be separated from the one contact point of the energy converter only by an electrical insulator. The heat conductor then directly adjoins one side of the electrical insulator, i.e. contacts it. The contact point then directly adjoins the other side of the electrical insulator.

For example, the electrical insulator may include a ceramic material with good thermal conductivity.

A thermal insulator may adjoin the heat conductor inside the probe. This ensures that the heat conductor is not cooled during the preparation of food with the thermometer inserted into it. The efficiency of the generation of electrical power can thus be further improved.

The other contact point of the energy converter may be thermally connected to the housing of the temperature sensor via a further heat conductor, for example consisting of copper, when the energy converter is located inside the probe. The other heat conductor may in turn be separated from the other contact point by an electrical insulator. However, the other contact point may also directly adjoin the housing of the probe in order to be tempered in a particularly suitable manner. Another electrical insulator may then be located between the other contact point and the housing of the probe. Again, the efficiency for generating electric power can thus be improved, If the energy converter is located in the handle part, the additional heat conductor may be connected to a housing part of the handle part. The further heat conductor may thus contact the part of the housing in which the heat conductor is located in order to improve electrical power generation.

The provision of one or two heat conductors is not mandatory to generate power according to the present disclosure. The energy converter can alternatively be dimensioned and arranged in such a way that one contact point is located in the area of the food thermometer which is kept comparatively cool during the preparation of a food and the other contact point is located in the area of the food thermometer which is heated more strongly during the preparation of a food. Therefore, one contact point may then be located in the probe and the other contact point outside the probe. For manufacturing reasons, however, the solution with one or two heat conductors is preferable.

A heat conductor may be one of the two electrical conductors of the energy converter.

The probe may have a pointed end. The probe can then be pierced into a food product particularly easily.

The food thermometer may comprise a handle part with a handle portion consisting of plastic. The handle part is used to grasp a food thermometer and insert it into a food product or to withdraw it from the food product or food.

The food thermometer may be pen-shaped. This shape is particularly suitable for realizing the thermometer in accordance with the present disclosure.

The energy converter may be electrically connected to a battery of the food thermometer. The electrical power generated by the energy converter can then be used to charge the battery.

1. A food thermometer comprising:
an elongated probe;
a temperature sensor disposed within the elongated probe;
an energy converter capable of generating an electrical power from a temperature difference; and
a heat conductor which is thermally conductively connected to the energy converter, wherein the heat conductor leads out of the probe when the energy converter is arranged inside the probe, and wherein the heat conductor leads into the probe when the energy converter is arranged outside the probe.

2. The food thermometer of claim 1, wherein the heat conductor includes copper.

3. The food thermometer-('of claim 1, wherein the heat conductor is completely or at least predominantly rod-shaped.

4. The food thermometer of claim 1, wherein the heat conductor extends from a rear third of the food thermometer to a front third of the food thermometer, and wherein the energy converter is arranged in one of the two thirds.

5. The food thermometer of claim 1, further comprising a radio device, wherein the heat conductor is an antenna of the radio device or an electrical conductor connected to electronics of the food thermometer or to a battery of the food thermometer.

6. The food thermometer of claim 1, wherein the energy converter comprises two different electrical conductors with two contact points for the generation of electrical power by means of Seebeck effect.

7. The food thermometer of claim 6, wherein the energy converter is hollow-cylindrical in shape.

8. The food thermometer of claim 7, wherein the heat conductor is led into the hollow cylindrical shape.

9. The food thermometer of claim 6, wherein the heat conductor adjoins one of the two contact points.

10. The food thermometer of claim 1, further comprising a thermal insulator adjoins the heat conductor within the probe.

11. The food thermometer of claim 6, wherein the other contact point is thermally conductively connected to the housing of the food thermometer via a further heat conductor including copper or directly adjoins the housing of the food thermometer.

12. The food thermometer of claim 1, wherein the probe has a pointed end.

13. The food thermometer of claim 1, further comprising a handle part with a handle portion including plastic.

14. The food thermometer of claim 1, wherein the food thermometer is pen-shaped.

15. The food thermometer of claim 1, wherein the energy converter is electrically connected to a battery of the food thermometer.

16. A food thermometer comprising:
an elongated probe having a first end for inserting into a food product and a second end configured to remain outside the food product;
an energy converter disposed within the probe and thermoelectrically coupled to the first and second ends thereof via a pair of heat conductors, the energy converter configured to generate electrical power in response to a difference between temperatures detected by the heat conductors during cooking of the food product; and
a control unit powered by a battery, wherein the energy converter is electrically coupled to charge the battery using the generated electrical power.

17. The food thermometer of claim 16, further comprising a radio signal receiver external to the probe, wherein one of the heat conductors operates as an antenna to transmit signals from the control unit to the radio signal receiver.

18. A food thermometer comprising:
an elongated probe;
a temperature sensor disposed within the elongated probe;
an energy converter capable of generating an electrical power from a temperature difference; and
a heat conductor which is thermally conductively connected to the energy converter, wherein the heat conductor leads out of the probe when the energy converter is arranged inside the probe, and wherein the heat conductor leads into the probe when the energy converter is arranged outside the probe,
wherein the energy converter comprises two different electrical conductors with two contact points for the generation of electrical power by means of Seebeck effect,
wherein the heat conductor adjoins one of the two contact points,
wherein the other contact point is thermally conductively connected to the housing of the food thermometer via a further heat conductor including copper or directly adjoins the housing of the food thermometer.
